(19) United States
(12) Patent Application Publication
(10) Pub. No.: US 2024/0153476 A1
(43) Pub. Date: May 9, 2024

(54) KEYBOARD APPARATUS AND KEYBOARD INSTRUMENT

(71) Applicant: CASIO COMPUTER CO., LTD., Tokyo (JP)

(72) Inventors: Kenzo ICHIKAWA, Tokyo (JP); Takahiro MIZUSHINA, Tokyo (JP); Wataru NIMURA, Tokyo (JP)

(73) Assignee: CASIO COMPUTER CO., LTD., Tokyo (JP)

(21) Appl. No.: 18/499,462

(22) Filed: Nov. 1, 2023

(30) Foreign Application Priority Data
Nov. 4, 2022 (JP) 2022-177122

(51) Int. Cl. G10H 1/34; G10C 3/12

(52) U.S. Cl. CPC G10H 1/344; G10C 3/12

(57) ABSTRACT

A keyboard apparatus has a hammer supported rotatably on a fulcrum, including a weight disposed further backwards than the fulcrum, and including an extending member configured to extend further forwards than the fulcrum, a key including a hammer press rod configured to move towards and away from the extending member, and a switch, and the extending member includes a press-down area configured to protrude further forwards than the hammer press rod to press down the switch, and the extending member is configured to press down the switch without contacting the hammer press rod.

### CROSS-REFERENCE TO RELATED APPLICATION

This patent application is based upon and claims the benefit of priority under 35 USC 119 of Japanese Patent Application No. 2022-177122 filed on Nov. 4, 2022, the entire disclosure of which, including the specification, claims, drawings and abstract, is incorporated herein by reference in its entirety.

### BACKGROUND

### Technical Field

The present disclosure relates to a keyboard apparatus and a keyboard instrument.

### Description of the Related Art

There have conventionally been disclosed keyboard apparatuses including a link mechanism. This link mechanism is configured such that a first link and a second link, which are provided to oscillate freely by a fixing fulcrum, are connected to a coupling link which is fixed to a key. In addition, the keyboard apparatus includes a hammer connected to a hammer press portion of the key at one end thereof and including a weight disposed at the other end which lies opposite across a fulcrum portion.

### SUMMARY

According to an aspect of the present disclosure, there is provided a keyboard apparatus having a hammer supported rotatably on a fulcrum, including a weight disposed further backwards than the fulcrum, and including an extending member configured to extend further forwards than the fulcrum, a key including a hammer press rod configured to move towards and away from the extending member, and a switch, wherein the extending member includes a press-down area configured to protrude further forwards than the hammer press rod to press down the switch, and wherein the extending member is configured to press down the switch without contacting the hammer press rod.

According to another aspect of the present disclosure, there is provided a keyboard instrument including the keyboard apparatus described above.

### BRIEF DESCRIPTION OF THE DRAWINGS

FIG. 1 is an overall perspective view of a keyboard instrument which includes a keyboard apparatus according to an embodiment of the present disclosure;

FIG. 2 is a perspective view of the keyboard apparatus according to the embodiment of the present disclosure as viewed from a left front side, showing schematically structures of a white key, a black key, link mechanisms, and the like of the keyboard apparatus in a steady state;

FIG. 3 is a perspective view of the keyboard apparatus according to the embodiment of the present disclosure as viewed from a right rear side, showing schematically the structures of the white key, the black key, the link mechanisms, and the like of the keyboard apparatus in the steady state;

FIG. 4 is a left side view of the keyboard apparatus according to the embodiment of the present disclosure showing schematically the white key and a link mechanism for the white key in the steady state, with the white key and a counterweight case shown in section;

FIG. 5 is a right side view of the keyboard apparatus according to the embodiment of the present disclosure showing schematically the white key and the link mechanism for the white key in the steady state;

FIG. 6 is a left side view of the keyboard apparatus according to the embodiment of the present disclosure showing schematically the black key and a link mechanism for the black key in the steady state, with the black key and a counterweight case shown in section;

FIG. 7 is a right side view of the keyboard apparatus according to the embodiment of the present disclosure showing schematically the black key and the link mechanism for the black key in the steady state;

FIG. 8 is a left side view, corresponding to FIG. 4, of the keyboard apparatus according to the embodiment of the present disclosure, showing schematically the white key and the link mechanism for the white key in a state in which the key is pressed;

FIG. 9A is a diagram illustrating operations of a hammer press rod and an extending member when the white key of the keyboard apparatus according to the embodiment of the present disclosure is struck strongly, that is, in a state in which the key is started to be struck;

FIG. 9B is a diagram illustrating operations of the hammer press rod and the extending member when the white key of the keyboard apparatus according to the embodiment of the present disclosure is struck strongly, that is, in a state in which the key is being struck;

FIG. 10A is a diagram illustrating operations of the hammer press rod and the extending member when the white key of the keyboard apparatus according to the embodiment of the present disclosure is struck weakly, that is, in a state in which the key is started to be struck; and

FIG. 10B is a diagram illustrating operations of the hammer press rod and the extending member when the white key of the keyboard apparatus according to the embodiment of the present disclosure is struck weakly, that is, in a state in which the key is being struck.

### DESCRIPTION OF THE EMBODIMENT

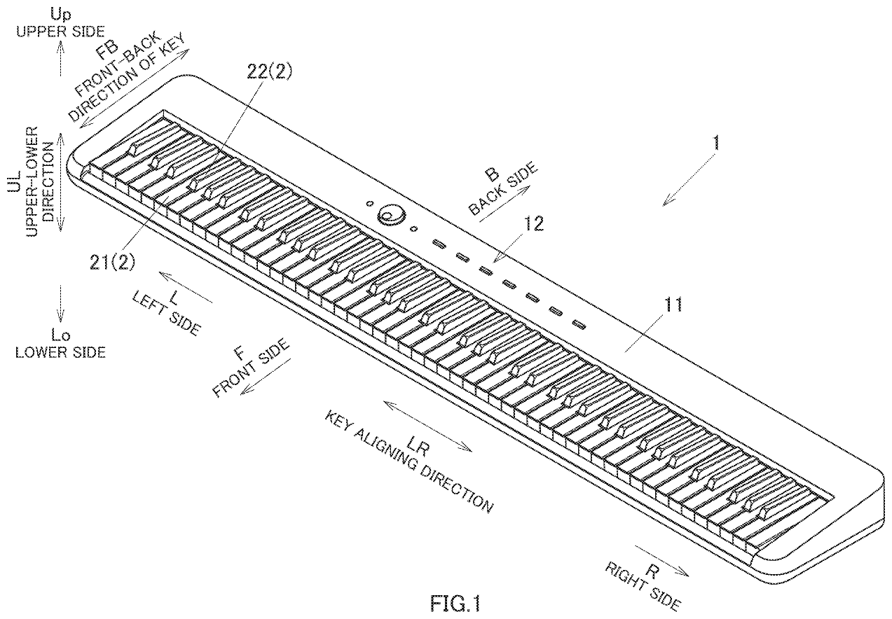

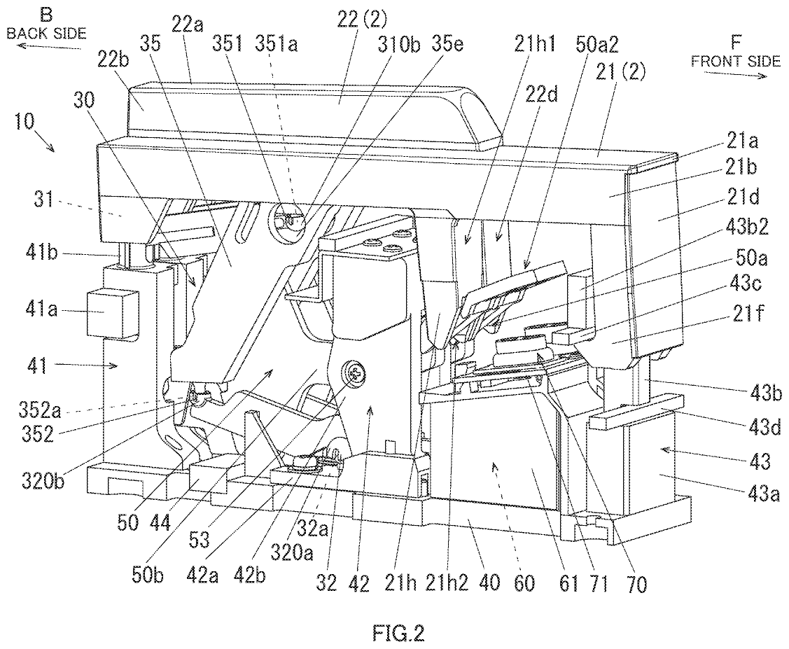

Hereinafter, referring to drawings, an embodiment of the present disclosure will be described. A keyboard instrument 1 shown in FIG. 1 includes a keyboard apparatus 10 (refer to FIG. 2) including a key 2, and a case 11. In the following description, a front of the key 2 in a front-back direction FB of the key is referred to as a front side F, and a back of the key 2 in the front-back direction FB of the key is referred to as a back side B. A left of the key 2 when the key 2 is seen from the front side F thereof is referred to as a left side L, and a right of the key 2 when the key 2 is seen from the front side F thereof is referred to as a right side R. A key aligning direction LR of the key 2 is referred to as a left-right direction. In addition, in an upper-lower direction UL of the keyboard instrument 1, a side in an upper direction is referred to as an upper side Up, and a side in a lower direction is referred to as a lower side Lo. In the present embodiment, although the keyboard instrument 1 is described as an electronic piano, the keyboard instrument 1 may be of any other type of keyboard instrument as long as it produces sound in response to a key press operation by a player (a user).

The keyboard instrument 1 has multiple keys 2 each functioning as a playing operation element configured to designate the pitch of a note and is formed into a flat plate-like shape which is elongated in the aligning direction LR (the left-right direction) of the keys 2. The keyboard instrument 1 includes a control panel 12, and this control panel 12 includes control buttons and a dial which are operated to select or decide on various types of settings and is disposed at the back of the keys 2. The keys 2 include white keys 21 and black keys 22. The white keys 21 and the black keys 22 are arranged regularly in the left-right direction of the keyboard instrument 1 in a predetermined order.

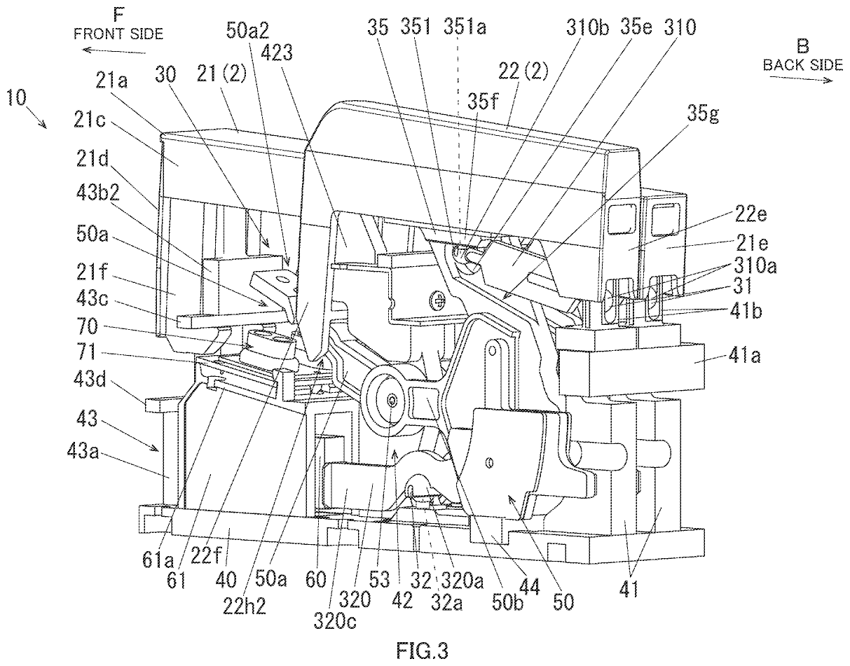

FIGS. 2 and 3 are structure drawings illustrating a structure of a keyboard apparatus 10 which includes a white key 21 and a black key 2 which make up the multiple keys 2. Structures of a link mechanism 30 disposed on a lower side of the white key 21, a base 40 having substantially a flat plate shape, and the like are accommodated in an interior of the case 11 of the keyboard instrument 1. Although details will be described later, the link mechanism 30 is connected individually to the white key 21 and the black key 22. The link mechanism 30 includes a counterweight 60. In addition, a hammer 50 includes a press-down area 50a2 configured to press down a sound generating switch 70. The key 2 can obtain a dynamic property close to a dynamic property of keys of a grand piano by being connected to the link mechanism 30. The link mechanism 30, the hammer 50, the counterweight 60, and the switch 70 are provided for each of the white key 21 and the black key 22 similarly, and the link mechanisms 30, the hammers 50, the counterweights 60, and the switches 70 of the white key 21 and the black key 22 have substantially the same configuration. Thus, to describe the configurations of these constituent elements of the white key 21 and the black key 22, the configurations of the constituent elements of the while key 21 will be described mainly by reference to FIGS. 2, 3, and 4 to 6.

The link mechanism 30 includes a first member 41 having a first fixing fulcrum 31, a long first link 310, a coupling link 35 (a first coupling point 351, a second coupling point 352), a long second link 320, and a second member 42 having a second fixing fulcrum 32. Here, in the present embodiment, the first link 310, the second link 320, and the coupling link 35 of the link mechanism 30, a coupling ball bearer 41b, which will be described later, provided on the first member 41, and a coupling ball 32a, which will be described later, provided on the second member 42 are formed from a resin material.

The white key 21 has an upper surface plate 21a which includes a surface where the white key 21 is pressed. In the white key 21, a left side plate 21b on the left side L, a right side plate 21c on the right side R, a front plate 21d on the front side F, and a back plate 21e on the back side B are provided on a lower side of the upper surface plate 21a. Thus, the white key 21 has substantially a shell shape. The white key 21 shown in FIGS. 1 to 6 is disposed for “C” or “F” in the keyboard instrument 1. As a result, the upper surface plate 21a and the right side plate 21c are provided substantially into a hook shape in a plan view so that the black key 22 can be disposed.

The front plate 21d and portions of the left side plate 21b and the right side plate 21c on the front side F extend towards the lower side Lo, whereby front legs 21f are provided on the white key 21. These front legs 21f have substantially a hook shape as a result of distal end portions of the portions of the left side plate 21b and the right side plate 21c being caused to extend towards the back side B. In addition, portions of the left side plate 21b and the right side plate 21c on the back side B bulge out towards the lower side Lo together with the back plate 21e.

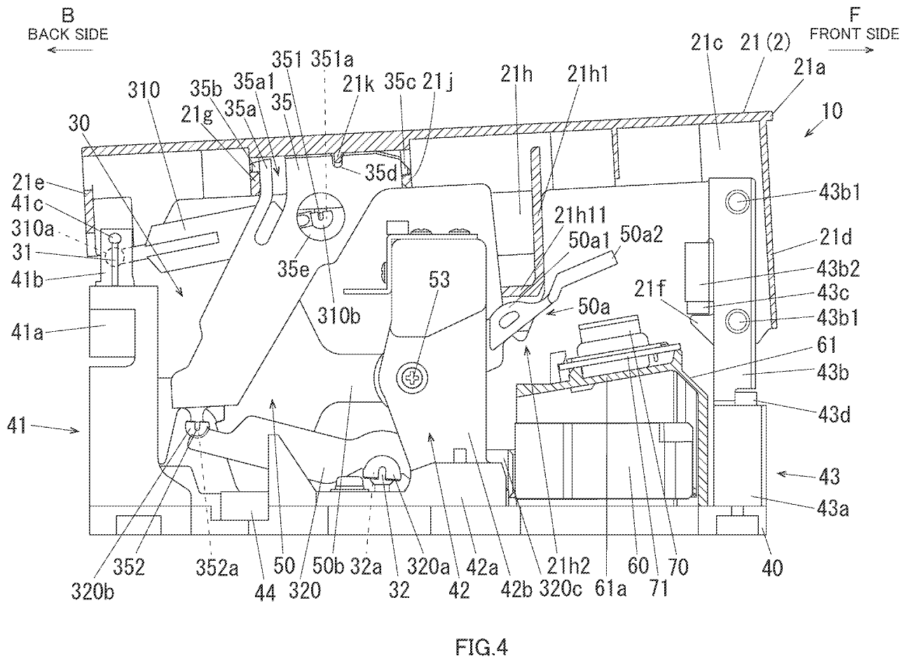

Other portions of the left side plate 21b and the right side plate 21c are made to extend towards the lower side Lo, whereby a hammer press rod 21h is provided between the front plate 21d and the back plate 21e of the white key 21. A plate-shaped hammer press rod front plate 21h1 is provided between the portions of the side plate 21b and the right side plate 21c which are made to extend to provide the hammer press rod 21h in such a manner as to extend therebetween while facing the front side F. As shown in FIG. 4, the hammer press rod front plate 21h1 includes a lower end portion 21h11 which is bent towards the back side B. This lower end portion 21h11 is opened downwards. In other words, a bifurcated distal end 21h2, which is made up of lower end portions of the portions of the left side plate 21b and the right side plate 21c which face each other, is provided at a distal end portion of the hammer press rod 21h.

The coupling link 35 is provided between the hammer press rod 21h and the back plate 21e of the white key 21. The coupling link 35 is provided substantially into a single plate which extends from a lower surface of the upper surface plate 21a of the white key 21 towards the lower side Lo with flat plate portions thereof oriented to face the left-right direction. In the coupling link 35, a U-shaped slit 35a1 is provided to extend from an upper end to thereby provide a plate spring 35a.

A protrusion 35b, which protrudes backwards, is provided on a side, facing the back side B, of a distal end (an upper end) portion of the plate spring 35a. A protrusion 35c, which protrudes forwards, is provided on a side, facing the front side F, of the upper end portion of the plate spring 35a in a position substantially corresponding to the protrusion 35b. A groove 35d is provided in an upper end of the coupling link 35 between the protrusions 35b, 35c in such a manner as to penetrate the coupling link 35 in the left-right direction.

Here, fixed walls 21g, 21j and a fitting rib 21k are provided between the left side plate 21b and the right side plate 21c of the white key 21. Then, the coupling link 35 is fixed to the white key 21 by virtue of a spring-back force of the plate spring 35a as a result of the protrusion 35b fitting in a hole in the fixed wall 21g and the protrusion 35c fitting in a hole in the fixed wall 21j of the white key 21. The coupling link 35 is positioned as a result of the groove 35d fitting on the fitting rib 21k. Here, the coupling link 35 may be integrated with the white key 21. The degree of freedom in assembling order for assemblage of constituent elements is increased by configuring the key 2 and the coupling link 35 as separate members as in the case with the present embodiment, which also facilitates the assemblage.

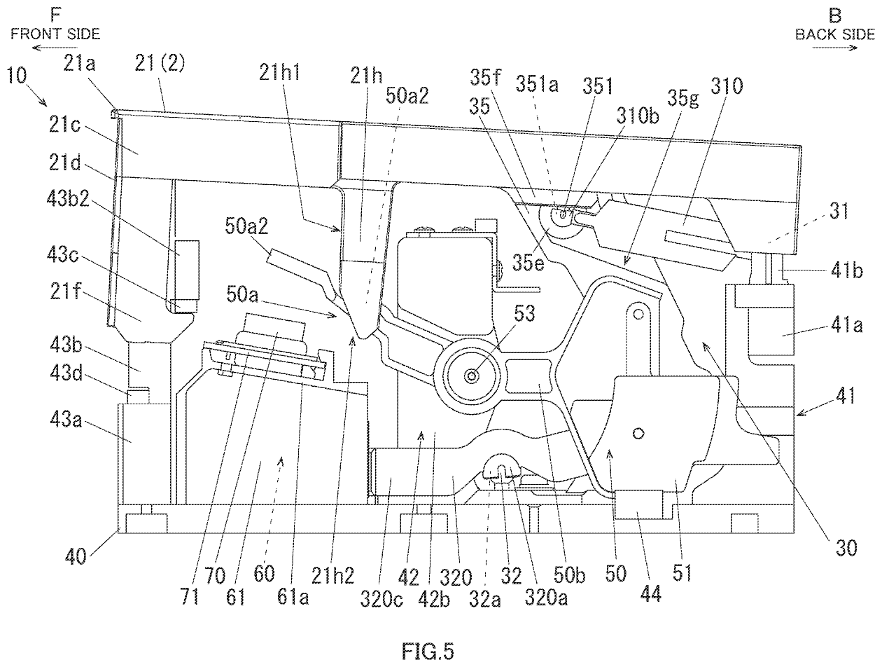

A circular hole 35e is provided in an upper portion of the coupling link 35 in such a manner as to penetrate the coupling link 35 in the key aligning direction LR. A coupling ball 351a is provided on a right side surface of the coupling link 35 in such a manner as to protrude from a lower surface of a bulging portion 35f (refer to FIGS. 3 and 5) which bulges out downwards. The coupling ball 351a is disposed in a position corresponding to the circular hole 35e. The coupling ball 351a is coupled with a coupling cup 310b disposed on the other end side of the first link 310 which lies opposite to one end side where slitting is provided through a cup-and-ball joint. A groove 35g (refer to FIGS. 3 and 5) is provided in the right side surface of the coupling link 35 so as to avoid an interference with the first link 310. The coupling ball 351a and the coupling cup 310b which are so coupled together constitute the first coupling point 351 as a coupling point. In other words, the other end side of the first link 310 is rotatably coupled with the first coupling point 351 of the coupling link 35.

In addition, a coupling ball 352a, which protrudes towards the lower side Lo, is also provided at a lower end of the coupling link 35 similarly. The coupling ball 352a is coupled with a coupling cup 320b disposed on the other end side of the second link 320 which lies opposite to one side where slitting is provided through a cup-and-ball joint. The coupling ball 352a and the coupling cup 320b which are so coupled together constitute the second coupling point 352 as a coupling point. In other words, the other end side of the second link 320 is rotatably coupled with the second coupling point 352 of the coupling link 35.

The first coupling point 351 is disposed further upwards to the upper side Up and further forwards towards the front side F than the second coupling point 352. A distance between the first coupling point 351 and the second coupling point 352 on the coupling link 35, which is formed into the single plate member, remains unchanged during a key operation.

The first member 41, having substantially a thick plate shape, is provided on a side, facing the back side B, of an upper surface of the base 40 with flat surface sides thereof oriented to face the key aligning direction LR. Here, the base 40 may be configured as a bottom plate of the case 11. An upper limit stopper 41a is provided on the first member 41, and this upper limit stopper 41a has substantially a quadrangular prism shape and is elongated in the key aligning direction LR. The upper limit stopper 41a constitutes a rising limit stopper for a weight 51 of the hammer 50, which will be described later, when the weight 51 is operated to oscillate. For example, an elastic member such as one made of felt is applied to the upper stopper 41a.

A coupling ball bearer 41b, which protrudes towards the upper side Up, is provided at an upper end of the first member 41. The coupling ball bearer 41b is provided substantially into a bifurcated pillar (also, refer to FIG. 3), and a coupling ball 310a, which is provided on the one end side of the first link 310, is coupled with the coupling ball bearer 41b through a cup-and-ball joint while being held in the bifurcated pillar. The coupling ball bearer 41b and the coupling ball 310a which are so coupled together constitutes the first fixing fulcrum 31. In other words, the one end side of the first link 310 is rotatably coupled with the first fixing fulcrum 31 of the first member 41.

The coupling ball bearer 41b is inserted between the left side plate 21b and the right side plate 21c on the back side B. A spherical guide 41c, which protrudes semi-spherically, is provided on each of left and right side surfaces of the coupling ball bearer 41b. The spherical guides 41c are brought into sliding contact with corresponding inner surfaces of the left side plate 21b and the right side plate 21c. The spherical guides 41c are intended to guide a movement of the key occurring in association with a key operation so as to prevent a lateral deviation of the white key 21 in the key aligning direction LR.

On the other hand, the second member 42 is provided on the front side F of the first member 41, that is, substantially at a center of the base 40 in the front-back direction FB. The second member 42 has a fixed plate 42a, which extends substantially into a flat plate on the upper surface of the base 40, and a substantially plate-shaped strut 42b, which is erected from the fixed plate 42a. The strut 42b is provided in such a manner that plate surfaces thereof are oriented to face the left-right direction. The coupling ball 32a is provided on the fixed plate 42a in such a manner as to protrude therefrom towards the upper side Up. On the other hand, a coupling cup 320a, in which slotting is provided, is provided on one end side of the second link 320. The coupling ball 32a is coupled with the coupling cup 320a on the one end side of the second link 320 through a cup-and-ball joint. The coupling ball 32a and the coupling cup 320a which are so coupled together constitute the second fixing fulcrum 32. In other words, the one end side of the second link 320 is rotatably coupled with the second fixing fulcrum 32 of the second member 42.

The second fixing fulcrum 32 is provided further forwards towards the front side F and further downwards towards the lower side Lo than the first fixing fulcrum 31. The one end side of the second link 320 is pivotally supported on the second fixing fulcrum 32. As described above, the other end side of the second link 320 is rotatably coupled with the second coupling point 352 of the coupling link 35. The coupling link 35 couples the first link 310 and the second link 320 together and is configured such that a distance between the other end side of the first link 310 which rotates about the first fixing fulcrum 31 in response to a key operation and the other end side of the second link 320 which rotates about the second fixing fulcrum 32 in response to the key operation is fixed and remains unchanged.

The coupling cup 320a of the second link 320 is provided at an arc-shaped portion lying substantially at a central portion of the second link 320 which is long in the front-back direction FB. Then, in the second link 320, the counterweight 60 is provided further forwards towards the front side F than the coupling cup 320a (the second fixing fulcrum 32). The counterweight 60 is provided fixedly at a distal end of an attachment rod 320c which extends further forwards towards the front side F than the second fixing fulcrum 32 of the second link 320.

The counterweight 60 is such that a flat rectangular parallelepiped body, which is long in the front-back direction FB, is disposed vertically (with larger flat surfaces thereof oriented to face the key aligning direction LR). The counterweight 60 is accommodated in an interior of a counterweight case 61 provided on the base 40. The counterweight case 61 is opened towards the back side B so as to match the attachment rod 320c which is connected to the counterweight 60. An upper surface plate 61a of the counterweight case 61 is provided in such a manner as to be inclined from the front side F towards the back side B so as to match a state in which the counterweight 60 is raised.

A substrate 71, on which the switch 70 is to be provided, is provided on an upper surface of the upper surface plate 61a of the counterweight case 61. The substrate 71 is disposed to slope down from the front side F to the back side B in such a manner as to follow the upper surface plate 61a. As a result, an upper surface of the switch 70 is also disposed to slope down from the front side F towards the back side B similarly. Although the counterweight case 61 and the substrate 71 are shown partially in FIGS. 2 to 8, the counterweight case 61 and the substrate 71 can be provided into one unit which is long in the key aligning direction LR.

A fulcrum 53 for the hammer 50 is provided on the strut 42b of the second member 42. The hammer 50 is fixed in such a manner as to rotate about the fulcrum 53. That is, the second member 42 is referred to as a hammer holder having the fulcrum 53 configured to pivotally support the hammer 50 for rotation. In other words, the hammer holder is integrated into the second member 42. As a specific structure of the fulcrum 53, for example, a structure can be adopted in which a shaft hole in the hammer 50 is pivotally supported in such a manner as to rotate around a shaft which is screwed to the strut 42b of the second member 42.

The hammer 50 has an extending member 50a which extends forwards of the fulcrum 53 towards the front side F, and has a connecting rod 50b which is disposed backwards of the fulcrum 53 towards the back side B. The extending member 50a and the connecting rod 50b are provided in such a manner as to be bent at the fulcrum 53. The extending member 50a includes a sliding-contact area 50a1, which is provided in such a manner as to protrude upwards into an arc shape towards the upper side Up, and the press-down area 50a2, which extends further forwards towards the front side F than the sliding-contact area 50a1 in such a manner as to be formed substantially into a flat plate.

The sliding-contact area 50a1 is disposed in a position corresponding to the hammer press rod 21h so as to be brought into sliding contact with a lower surface f a lower end portion 21h11 of the hammer press rod front plate 21h1. In this way, the hammer press rod 21h is provided in such a manner that the sliding-contact area 50a1 of the extending member 50a moves towards and away from a space defined in the bifurcated distal end 21h2 of the hammer press rod 21h. In addition, the press-down area 50a2 protrudes further forwards towards the front side F than the hammer press rod 21h so as to constitute an area which is configured to be brought into abutment with an upper surface of the switch 70 to press down the switch 70.

Here, the extending member 50a can also include a hammer cap. Specifically speaking, a part or a whole of the extending member 50a can be made into a hammer cap which is made up of an elastic material such elastomer, silicone resin, or the like. In this case, the press-down area 50a2 can be provided on the hammer cap.

On the other hand, the weight 51, having a wide plate shape, is provided at a distal end portion of the connecting rod 50b (one end side of the hammer 50) on the back side B of the hammer 50. The weight 51 is provided such that multiple plate-shaped weight plates are fixed to a main body portion which is connected to the connecting rod 50b.

A front leg guide 43, having substantially a pillar shape, is provided on the base 40 in a position lying further forwards towards the front side F than the second member 42. The front leg guide 43 includes a proximal portion 43a, which has a prism shape and is provided on the base 40, and a key guide 43b, which is narrower in width than the proximal portion 43a and is disposed between the left and right front legs 21f of the white key 21. The key guide 43 is provided substantially into a pillar which is long in a vertical direction, and a spherical guide 43b1 is provided at two upper and lower portions on each of left and right side surfaces of the key guide 43b. The spherical guides 43b1 of the key guide 43b are brought into sliding contact with inner surfaces of the front legs 21f so as to guide a movement of the key occurring in association with a key operation, and thus, the spherical guides 43b1 are intended to prevent a lateral deviation of the white key 21 in the key aligning direction LR.

A protrusion beam 43b2 is provided on the key guide 43b in such a manner as to protrude towards the back side B. A lower limit stopper 43c, which is made up of an elastic material such as felt, is provided on a lower surface of the protrusion beam 43b2. In addition, a lower limit stopper 43d, which is made up of an elastic material such as felt, is provided on an upper surface of the proximal portion 43a of the front leg guide 43. Upper surfaces of hook portions of the front legs 21f are brought into abutment with the upper limit stopper 43c, whereby the white key 21 is restricted from rising. Similarly, lower surfaces of the hook portions of the front legs 21f are brought into abutment with the lower limit stopper 43d, whereby the white key 21 is restricted from falling.

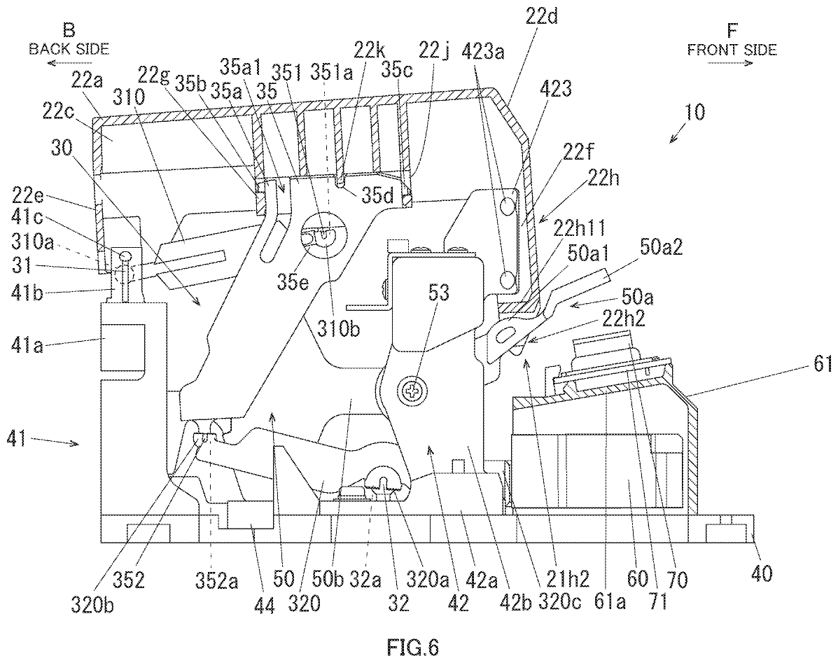

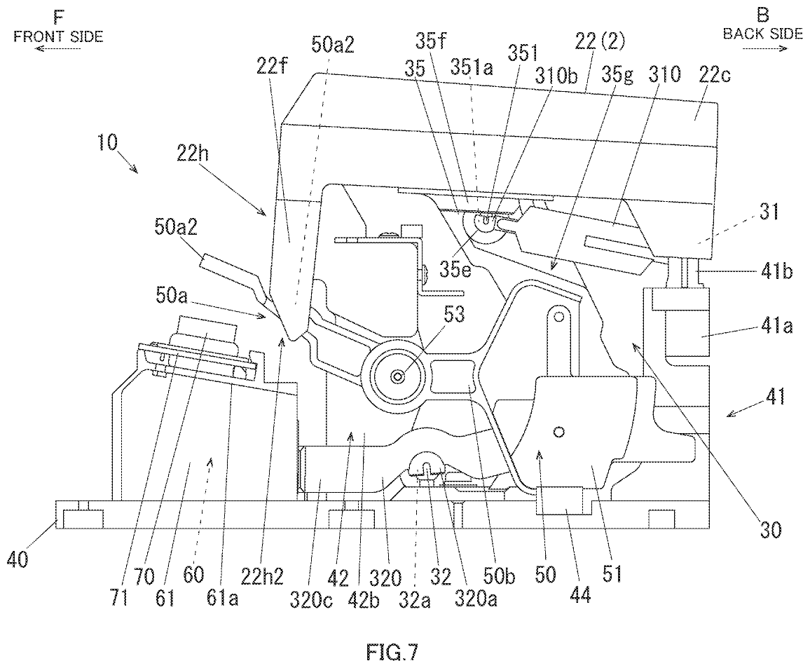

As with the white key 21, the black key 22 also includes the link mechanism 30, the hammer 50, the switch 70, and the like. As a result, for description of the black key 22 and the link mechanism 30, the hammer 50, and the like which are associated with the black key 22, like reference numerals are given to like members and like portions so as to omit or simplify descriptions thereof. Thus, structures differing from those of the white key 21 will be described based on FIGS. 6 and 7. The black key 22 includes an upper surface plate 22a including a surface where the black key 22 is pressed, a left side plate 22b, a right side plate 22c, and a back plate 22e. Side surfaces of the left side plate 22b and the right side plate 22c of the black key 22 which lie on the front side F are made to extend towards the lower side Lo so as to constitute front legs 22f which face each other in the left-right direction. A front plate 22d is provided on the black key 22 in such a manner as to cover a space defined between the left side plate 22b and the right side plate 22c and a space defined between the front legs 22f. In the black key 22, a hammer press rod 22h is formed by the front legs 22f and the front plate 22d. That is, in the front plate 22d, a lower end portion 22h11 of the front plate 22d is bent towards the back side B in a position above a lower end of the front leg 22f, and the lower end portion 22h11 is opened downwards. As a result, a bifurcated distal end 22h2, which is made up of lower end portions of the facing front legs 22f, is provided at a distal end portion, constituting a lower end, of the hammer press rod 22h. Here, the distal end portions of the front legs 22f are shaped to taper off.

On the other hand, a second member 42 includes a guide plate 423, which is inserted between the front legs 22f of the black key 22 with plate surfaces thereof oriented to face the left-right direction. Two upper and lower spherical guides 423a are provided on each of left and right side surfaces of the guide plate 423 in such a manner as to be brought into sliding contact with inner surfaces of the front legs 22f. The black key 22 is guided by the spherical guides 423a.

As with the white key 21, a spherical guide 41c is provided on a coupling ball bearer 41b on the back side B of the black key 22, whereby portions of the left side plate 22b and the right side plate 22c which bulge out downwards are guided thereby. As with the white key 21, the black key 22 includes a fixed wall 22g having a hole in which a protrusion 35b on the coupling link 35 is fitted, a fixed wall 22j having a hole in which a protrusion 35c is fitted, and a fitting rib 22k which is fitted in a groove 35d.

The front legs 22f of the black key 22 are made to make up the hammer press rod. A bifurcated distal end 22fa is provided between distal ends (lower ends) of the front legs 22f of the black key 2, and an extending member 50a of the hammer 50 for the black key 22 is provided in such a manner as to move towards and away from the bifurcated distal end 22fa.

The key 2 operates as below. Here, the operation of the white key 21 will be described as an example. In a steady state in which no key press operation is performed as shown in FIGS. 2 to 5, in the white key 21, the weight 51 of the hammer 50 is positioned downwards due to its own weight, and the weight 51 is in abutment with a cushion 44 disposed on the base 40 in such a manner as to face the weight 51. On the other hand, the extending member 50a, which is disposed opposite to the weight 51 across the fulcrum 53, is positioned upwards. The sliding contact area 50a1 of the extending member 50a pushes up the lower end portion 21h11 of the hammer press rod front plate 21h1, whereby the upper surfaces of the hook portions of the front legs 21f are left in abutment with the upper limit stopper 43c.

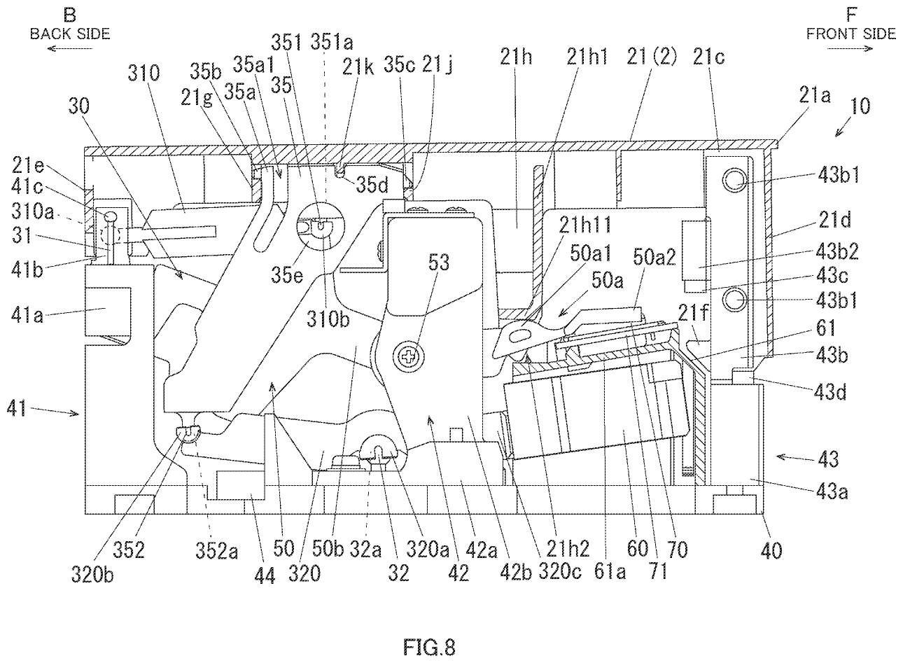

As shown in FIG. 8, when the white key 21 is pressed, the extending member 50a is pushed down against the own weight of the weight 51 of the hammer 50 by the hammer press rod 21h (specifically, a lower surface of the lower end portion 21h11 of the hammer press rod front plate 21h1 which is brought into abutment with the sliding contact area 50a1 of the extending member 50a for sliding contact). Then, the hammer 50 rotates about the fulcrum 53, whereby the weight 51 is caused to rise. When the weight 51 rises, the press-down area 50a2 of the extending member 50a, which lies opposite to the weight 51 across the fulcrum 53, is lowered downwards, whereby the press-down area 50a2 is brought into abutment with the upper surface of the switch 70 to thereby press down the switch 70. In this way, the press-down area 50a2 is interlocked with the key 2, and the switch 70 corresponding to each key 2 is pressed down by the press-down area 50a2, whereby a note corresponding to each key is sounded. Then, the weight 51 is brought into abutment with the upper limit stopper 41a, and the lower surfaces of the front legs 21f are brought into abutment with the lower limit stopper 43d, whereby the key press operation is completed. Here, the black key 22 also operates similarly.

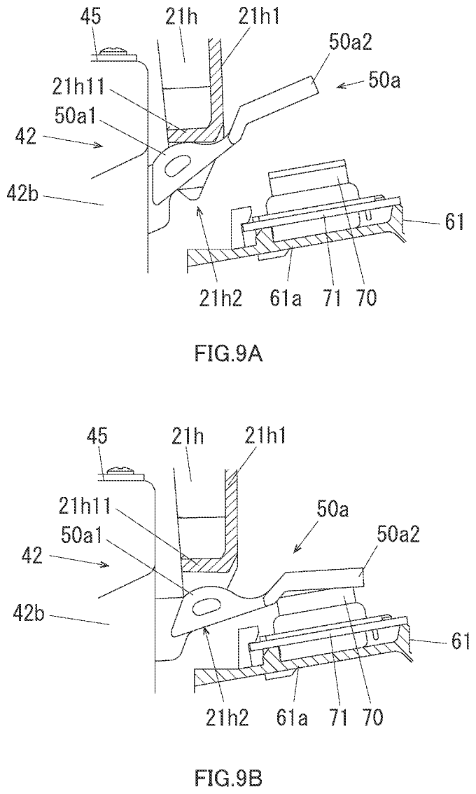

In addition, as described above, the sliding contact area 50a1 of the extending member 50a is provided in such a manner as to move towards and away from the bifurcated distal end 21h2, 22h2 of the hammer press rod 21h, 22h. As a result, in the case that the key 2 (the white key 21 in FIG. 8) is struck or pressed strongly, at the beginning of the press operation shown in FIG. 9A, the sliding contact area 50a1 and the lower surface of the lower end portion 21h11 of the bifurcated distal end 21h2 are in abutment with each other. However, the sliding contact area 50a1 moves away from the lower end portion 21h11 by virtue of the inertial force of the extending member 50a before the key 2 reaches its lower limit position as shown in FIG. 9B, and the switch 70 is pressed down by the press-down area 50a2 before the key 2 is pressed down completely. That is, the extending member 50a can press down the switch 70 without contacting the hammer press rod 21h, 22h.

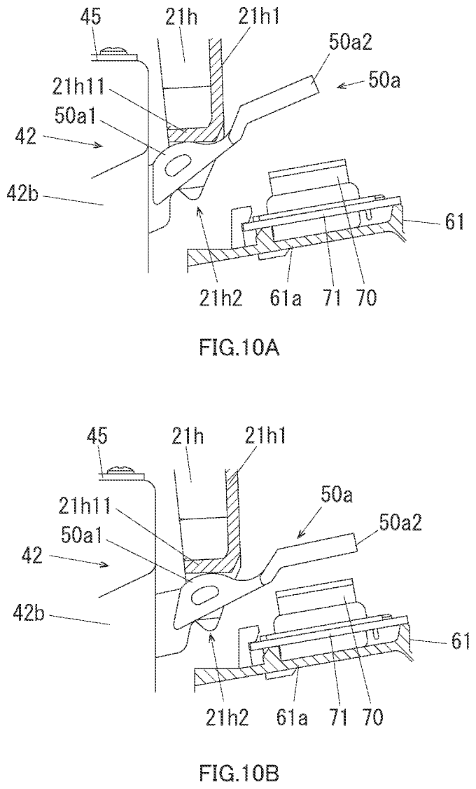

On the other hand, in the case that the key 2 is pressed weakly, even at the beginning of the press operation shown in FIG. 10A, or even before the key 2 reaches its lower limit position as shown in FIG. 10B, the sliding contact area 50a1 and the lower surface of the lower end portion 21h11 remain in abutment with each other. That is, the sliding contact area 50a1 and the lower surface of the lower end portion 21h11 are left in abutment with each other over a whole range of the stroke of the key 2. In this way, with the keyboard instrument 1 (the keyboard apparatus 10), when the key 2 is struck strongly, the extending member 50a which is pressed by the hammer press rod 21h, 22h of the key 2 moves away from the key 2 to thereby switch on the switch 70 as if by being thrown away, thereby making it possible to realize a playing feeling close to an action and an operation of a grand piano. Then, when the switch 70 is switched on, an external member of a rubber material which makes up the switch 70 is collapsed, however, since the extending member 50a including the press-down area 50a2 moves away from the hammer press rod 21h, 22h, it becomes difficult to transfer a feeling of collapsing the rubber external member to the finger of the player, thereby making it possible to improve the playing feeling.

In the present embodiment, when the key 2 (the white key 21, the black key 22) is pressed, the coupling link 35 moves upwards and downwards while being restricted by the first link 310 and the second link 320 in such a state that the distance between the first coupling point 351 and the second coupling point 352 is fixed. In other words, the coupling link 35 moves upwards and downwards with an imaginary link rotating which couples the first coupling point 351 and the second coupling point 352 together. Then, not only a front end portion of the key 2 but also a back end portion of the key 2 moves vertically. That is, an imaginary rotation center is set on a prolonged line (rearwards of the key 2) which connects the front end portion with the back end portion of the key 2, whereby the key 2 can obtain a dynamic property closed to that of a grand piano.

Then, the counterweight 60, which is provided further forwards towards the front side F than the second fixing fulcrum 32 of the second link 320, rises as the key 2 lowers, and rises as the hammer 50 rises. Referring to FIGS. 4 and 8, the counterweight 60 rotates counterclockwise, while the hammer 50 rotates clockwise. The facilitation of balancing the weight 51 relative to the key 2 in the front-back direction (balancing for a key press operation) and adjusting the weight of the weight 51 is realized by the counterweight 60, and the counterweight 60 can be interlocked with the weight 51 by making use of not only the hammer 50 but also the members connecting to the hammer 50.

With the link mechanism 30 according to the present embodiment, the first link 310 and the second link 320 are coupled with the first member 41, the second member 42, and the coupling link 35 through the cup-and-ball joint. In other words, the first fixing fulcrum 31, the second fixing fulcrum 32, the first coupling point 351, and the second coupling point 352 are pivotally supported in such a manner as to rotate through the cup-and-ball joint. However, the pivotal support through the cup-and-ball joint is not limited to the cup-and-ball joint, and hence, for example, a configuration made up of a shaft and a bearing can also be adopted for the pivotal support.

In the case that a player tries to play a conventional keyboard instrument including a conventional keyboard apparatus quickly by flipping keys, a positional relationship between a portion for pressing a sound generating switch and the switch in a key remains constant irrespective of a force with which the key is pressed, as a result of which it is difficult for the player to play the conventional keyboard instrument as quickly as playing a grand piano. In this way, with the conventional keyboard apparatus, it is often difficult to obtain a key striking or press feeling close to that of a grand piano.

In contrast with this conventional keyboard apparatus, with the embodiment of the present disclosure, the keyboard apparatus 10 has the hammer 50, which is supported rotatably on the fulcrum 53, includes the weight 51 disposed further backwards towards the back side B than the fulcrum 53, and includes the extending member 50a which extends further forwards to the front side F than the fulcrum 53, the key 2, which includes the hammer press rod 21h, 22h which is configured to move towards and away from the extending member 50a, and the switch 70. The extending member 50a includes the press-down area 50a2 which protrudes further forwards towards the front side F than the hammer press rod 21h, 22h to press down the switch 70, whereby the extending member 50a can press down the switch 70 without contacting the hammer press rod 21h, 22h.

As a result, with the keyboard apparatus 10, when the key 2 is struck strongly, the extending member 50a of the hammer 50 which is pressed by the key 2 moves away from the hammer press rod 21h, 22h (that is, the key 2) to thereby press down the switch 70 as if by being thrown away, thereby making it possible to obtain a key striking or press feeling close to a key striking or press feeling which is obtained or felt when a key of a grand piano is flipped quickly or is struck strongly. That is, the extending member 50a moves away from the key 2 to thereby press the switch 70 as if by being thrown away, whereby the switch 70 is pressed earlier than a case in which the key 2 is in contact with the hammer press rod 21h, 22h. In addition, as this occurs, when the switch 70 is pressed, it becomes difficult to transfer a feeling of collapsing a rubber contact existing at a contact portion of the switch 70 to the finger of the player, thereby making it possible to obtain a key striking or press feeling which is closer to that of a grand piano.

The hammer press rod 21h includes the bifurcated distal end 21h2, 22fa towards and away from which the extending member 50a moves. As a result, the press-down area 50a2 is never restricted from pressing down the switch 70. When the key 2 is pressed quickly, the extending member 50a can move away from the bifurcated distal end 21h2, 22fa to thereby press down the switch 70 early. In addition, when the key 2 is pressed slowly, the bifurcated distal end 21h2, 22faand the extending member 50a are brought into contact with each other, whereby the press-down area 50a2 can operate as the key 2 moves accordingly.

The switch 70 is disposed in such a manner as to slope down from the front side F towards the back side B. As a result, for the extending member 50a which oscillates, the flat upper surface of the switch 70, which constitutes a press target surface thereof, and the press-down area 50a2, which is formed into a flat surface, are brought into surface abutment with each other, whereby the switch 70 can be pressed down in an ensured fashion.

The key 2 is connected with the link mechanism 30. The link mechanism 30 has the first member 41 having the first fixing fulcrum 31, the first link 310 which is pivotally supported by the first fixing fulcrum 31 on one end side thereof, the second member 42 having the second fixing fulcrum 32 which is provided further forwards to the front side F and further downwards towards the lower side Lo than the first fixing fulcrum 31, the second link 320 which is pivotally supported by the second fixing fulcrum 32 on one end side thereof, and the coupling link 35 configured such that the distance between the other end side of the first link 310 which rotates about the first fixing fulcrum 31 in response to a key operation and the other end side of the second link 320 which rotates about the second fixing fulcrum 32 in response to the key operation is fixed and remains unchanged. As a result, the operation of the key 2 can be made close to the dynamic property of a grand piano.

The coupling point (the first coupling point 351) of the coupling link 35 with the first link 310 is disposed further upwards towards the upper side Up and further forwards towards the front side F than the coupling point (the second coupling point 352) of the coupling link 35 with the second link 320. As a result, the key 2 can obtain a moving amount and a rotation angle which are close to those of a grand piano by setting angles and moving amounts of the first coupling point 351 and the second coupling point 352 as required.

The extending member 50a includes the hammer cap. As a result, the hammer 50 can adopt a two-part configuration in which the hammer 50 is made of metal, and the sliding contact portion which is brought into sliding contact with the hammer press rod 21h is made into a hammer cap made from resin.

Then, a keyboard instrument including a keyboard apparatus which can obtain a key striking or press feeling close to that of a grand piano can be provided by the keyboard instrument 1 including the keyboard apparatus 10, the keyboard instrument 1 being described as the electronic piano in the present embodiment.

While the embodiment of the present disclosure has been described heretofore, the embodiment is presented as the example, and hence, there is no intention to limit the scope of the present invention by the embodiment. The novel embodiment can be carried out in other various forms, and various omissions, replacements, and modifications can be made thereto without departing from the spirit and scope of the invention. Those resulting embodiments and modified examples thereof are included in the scope and gist of the invention and are also included in the scope of inventions claimed for patent under claims below and their equivalents.

What is claimed is:

1. A keyboard apparatus comprising:
a hammer supported rotatably on a fulcrum, comprising a weight disposed further backwards than the fulcrum, and comprising an extending member configured to extend further forwards than the fulcrum;
a key comprising a hammer press rod configured to move towards and away from the extending member; and
a switch,
wherein the extending member comprises a press-down area configured to protrude further forwards than the hammer press rod to press down the switch, and
wherein the extending member is configured to press down the switch without contacting the hammer press rod.

2. The keyboard apparatus according to claim 1,
wherein the hammer press rod comprises a bifurcated distal end configured to move towards and away from the extending member.

3. The keyboard apparatus according to claim 1,
wherein the switch is disposed in such a manner as to slope down from a front side towards a back side.

4. The keyboard apparatus according to claim 1,
wherein the key is connected with a link mechanism, and
wherein the link mechanism comprises:
a first member comprising a first fixing fulcrum;
a first link pivotally supported by the first fixing fulcrum on one end side thereof;
a second member comprising a second fixing fulcrum provided further forwards and further downwards than the first fixing fulcrum;
a second link pivotally supported by the second fixing fulcrum on one end side thereof; and
a coupling link configured such that a distance between an other end side of the first link which rotates about the first fixing fulcrum in response to a key operation and an other end side of the second link which rotates about the second fixing fulcrum in response to the key operation is fixed and remains unchanged.

5. The keyboard apparatus according to claim 4,
wherein a coupling point of the coupling link with the first link is disposed further upwards and further forwards than a coupling point of the coupling link with the second link.

6. The keyboard apparatus according to claim 1, wherein the extending member comprises a hammer cap.

7. A keyboard instrument comprising the keyboard apparatus according to claim 1.

8. A keyboard instrument comprising the keyboard apparatus according to claim 2.

9. A keyboard instrument comprising the keyboard apparatus according to claim 3.

10. A keyboard instrument comprising the keyboard apparatus according to claim 4.

11. A keyboard instrument comprising the keyboard apparatus according to claim 5.

12. A keyboard instrument comprising the keyboard apparatus according to claim 6.
